(19) United States
(12) Patent Application Publication
(10) Pub. No.: US 2016/0063671 A1
(43) Pub. Date: Mar. 3, 2016

(54) A METHOD AND APPARATUS FOR UPDATING A FIELD OF VIEW IN A USER INTERFACE

(71) Applicants: Petri PIIPPO, Lempäälä (FI); Sampo VAITTINEN, Helsinki (FI); Juha ARRASVUORI, Tampere (FI)

(72) Inventors: Petri PIIPPO, Lempäälä (FI); Sampo VAITTINEN, Helsinki (FI); Juha ARRASVUORI, Tampere (FI)

(73) Assignee: NOKIA CORPORATION, Espoo (FI)

(21) Appl. No.: 14/424,169

(22) PCT Filed: Aug. 30, 2012
(86) PCT No.: PCT/FI2012/050839

§ 371 Date: May 25, 2015

(51) Int. Cl. G06T 3/20; G06T 7/00; G06T 11/60

(52) U.S. Cl. CPC G06T 3/20; G06T 11/60; G06T 7/0042

(57) ABSTRACT

There is inter alia a method comprising: determining an image of at least one object in a perspective view of a user interface which corresponds to at least one object in a field of view, wherein the at least one object obscures at least part of an area of the field of view; rendering a graphical representation of the field of view in the user interface to represent the at least part of the area of the field of view which is at least in part obscured by the at least one object; and overlaying the rendered graphical representation of the field of view on a plan view of the user interface, wherein the plan view corresponds to a map of the perspective view of the user interface.

### FIELD OF THE APPLICATION

The present application relates to a user interface, and more specifically the updating of the field of view within the user interface.

### BACKGROUND OF THE APPLICATION

Mapping and navigating services may comprise a combination of digital maps and images of panoramic street level views from the perspective of the user. For instance, a user may be presented with a digital map augmented with 360 degree panoramic street level views of various locations and points of interest from the current location and view point of the user. The mapping and navigational information may be presented to the user in the form of two dimensional map view, and a corresponding augmented reality panoramic street level view.

The map view can indicate the field of view from the perspective of the user by projecting a representation of the field of view over the two dimensional map. Furthermore the field of view as projected on the two dimensional map can correspond with an augmented reality panoramic view of what the user can see.

However, the projected user's field of view on to the map may not accurately match the view the user has in reality and also the view provided by the corresponding augmented reality panoramic street level view image.

### SUMMARY OF THE APPLICATION

The following embodiments aim to address the above problem.

There is provided according to an aspect of the application a method comprising: determining an image of at least one object in a perspective view of a user interface which corresponds to at least one object in a field of view, wherein the at least one object obscures at least part of an area of the field of view; rendering a graphical representation of the field of view in the user interface to represent the at least part of the area of the field of view which is obscured by the at least one object; and overlaying the rendered graphical representation of the field of view on a plan view of the user interface, wherein the plan view corresponds to a map of the perspective view of the user interface.

The method may further comprise: processing an indication to the user interface that indicates at least part of the image of the at least one object in the perspective view of the user interface may be removed from the perspective view of the user interface; and rendering the graphical representation of the field of view in the user interface to represent the field of view resulting from the removal of the at least part of the image of the at least one object in the perspective view of the user interface.

The rendering of the graphical representation of the field of view in the user interface to represent the at least part of the area of the field of view which is obscured by the at least one object may comprise: shaping the graphical representation of the field of view around an area at a specific position in the plan view of the user interface, wherein the area at the specific position in the plan view represents both the position of the at least one object in the field of view and the at least part of the area of the field of view which is obscured by the at least one object.

The method may further comprise augmenting the perspective view of the user interface with image data portraying the view behind the at least part of the at least one object when the at least part of the image of the at least one object is indicated for removal in the perspective view of the user interface.

The perspective view of the user interface may comprise a panoramic image of an area comprising the field of view.

The perspective view of the user interface may comprise a live camera view of an area comprising the field of view.

The user interface may at least be part of a location based service of a mobile device.

According to a further aspect of the application there is provided an apparatus configured to: determine an image of at least one object in a perspective view of a user interface which corresponds to at least one object in a field of view, wherein the at least one object obscures at least part of an area of the field of view; render a graphical representation of the field of view in the user interface to represent the at least part of the area of the field of view which is obscured by the at least one object; and overlay the rendered graphical representation of the field of view on a plan view of the user interface, wherein the plan view corresponds to a map of the perspective view of the user interface.

The apparatus may be further configured to: process an indication to the user interface indicating that at least part of the image of the at least one object in the perspective view of the user interface is to be removed from the perspective view of the user interface; and render the graphical representation of the field of view in the user interface to represent the field of view resulting from the removal of the at least part of the image of the at least one object in the perspective view of the user interface

The apparatus configured to render the graphical representation of the field of view in the user interface to represent the at least part of the area of the field of view which is obscured by the at least one object may be further configured to: shape the graphical representation of the field of view around an area at a specific position in the plan view of the user interface, wherein the area at the specific position in the plan view represents both the position of the at least one object in the field of view and the at least part of the area of the field of view which is obscured by the at least one object.

The apparatus may be further configured to augment the perspective view of the user interface with image data portraying the view behind the at least part of the image of the at least one object when the at least part of the at least one object is indicated for removal in the perspective view of the user interface.

The perspective view of the user interface may comprise a panoramic image of an area comprising the field of view.

The perspective view of the user interface may comprise a live camera view of an area comprising the field of view.

The user interface may at least part of a location based service of a mobile device.

According to another aspect of the application there is provided an apparatus comprising at least one processor and at least one memory including computer code for one or more programs, the at least one memory and the computer code configured with the at least one processor to cause the apparatus at least to: determine an image of at least one object in a perspective view of a user interface which corresponds to at least one object in a field of view, wherein the at least one object obscures at least part of an area of the field of view; render a graphical representation of the field of view in the user interface to represent the at least part of the area of the field of view which is obscured by the at least one object; and overlay the rendered graphical representation of the field of view on a plan view of the user interface, wherein the plan view corresponds to a map of the perspective view of the user interface.

The apparatus, in which the at least one memory and the computer code configured with the at least one processor may be further configured to cause the apparatus at least to: process an indication to the user interface indicating that at least part of the image of the at least one object in the perspective view of the user interface is to be removed from the perspective view of the user interface; and render the graphical representation of the field of view in the user interface to represent the field of view resulting from the removal of the at least part of the image of the at least one object in the perspective view of the user interface

The at least one memory and the computer code configured with the at least one processor configured to cause the apparatus at least to render the graphical representation of the field of view in the user interface to represent the at least part of the area of the field of view which is obscured by the at least one object may be further configured to cause the apparatus at least to: shape the graphical representation of the field of view around the an area at a specific position in the plan view of the user interface, wherein the area at the specific position in the plan view represents both the position of the at least one object in the field of view and the at least part of the area of the field of view which is obscured by the at least one object.

The apparatus, wherein the at least one memory and the computer code configured with the at least one processor may be further configured to cause the apparatus at least to: augment the perspective view of the user interface with image data portraying the view behind the at least part of the at least one object when the at least part of the image of the at least one object is indicated for removal in the perspective view of the user interface.

The perspective view of the user interface may comprise a panoramic image of an area comprising the field of view.

The perspective view of the user interface may comprise a live camera view of an area comprising the field of view.

The user interface may be at least part of a location based service of a mobile device.

According to yet another aspect of the application there is provided a computer program code which when executed by a processor realizes: determining an image of at least one object in a perspective view of a user interface which corresponds to at least one object in a field of view, wherein the at least one object obscures at least part of an area of the field of view; rendering a graphical representation of the field of view in the user interface to represent the at least part of the area of the field of view which is obscured by the at least one object; and overlaying the rendered graphical representation of the field of view on a plan view of the user interface, wherein the plan view corresponds to a map of the perspective view of the user interface.

The computer program code when executed by the processor may further realize: processing an indication to the user interface indicating that at least part of the image of the at least one object in the perspective view of the user interface is to be removed from the perspective view of the user interface; and rendering the graphical representation of the field of view in the user interface to represent the field of view resulting from the removal of the at least part of the image of the at least one object in the perspective view of the user interface

The computer program code when executed by the processor to realize rendering the graphical representation of the field of view in the user interface to represent at least part of the area of the field of view which is obscured by the at least one object may further realize: shaping the graphical representative field of view around an area at a specific position in the plan view of the user interface, wherein the area at the specific position in the plan view represents both the position of the at least one object in the field of view and the at least part of the area of the field of view which is obscured by the at least one object.

The computer program code when executed by the processor may further realize: augmenting the perspective view of the user interface with image data portraying the view behind the at least part of the at least one object when the at least part of the image of the at least one object is indicated for removal in the perspective view of the user interface.

The perspective view of the user interface may comprise a panoramic image of an area comprising the field of view.

The perspective view of the user interface may comprise a live camera view of an area comprising the field of view.

The user interface may be at least part of a location based service of a mobile device.

For better understanding of the present invention, reference will now be made by way of example to the accompanying drawings in which:

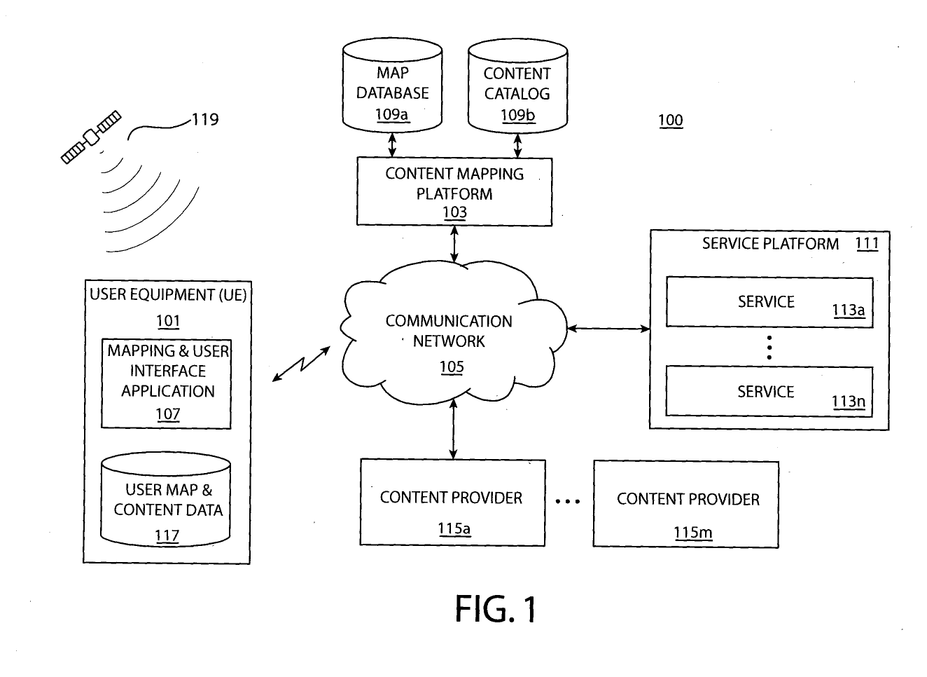

FIG. 1 shows schematically a system capable of employing embodiments;

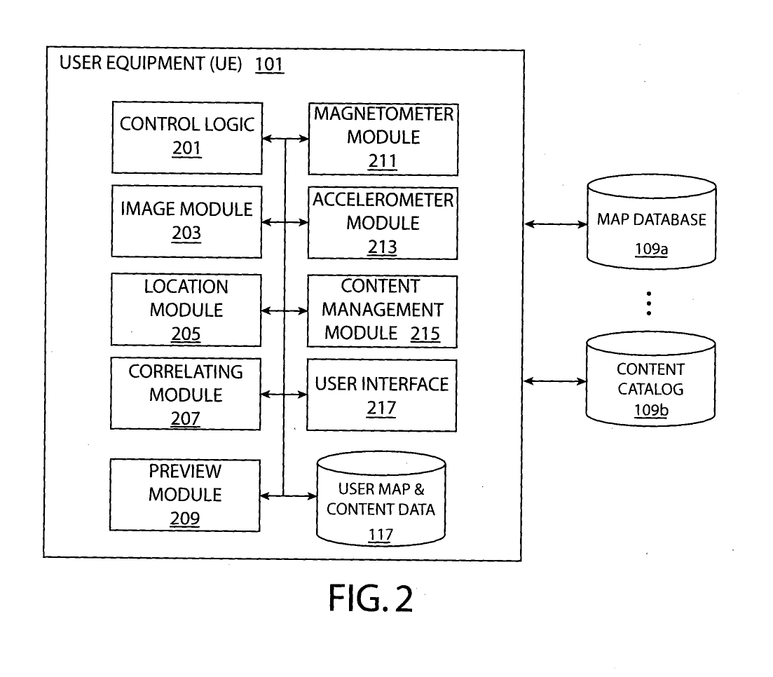

FIG. 2 shows schematically user equipment suitable for employing embodiments;

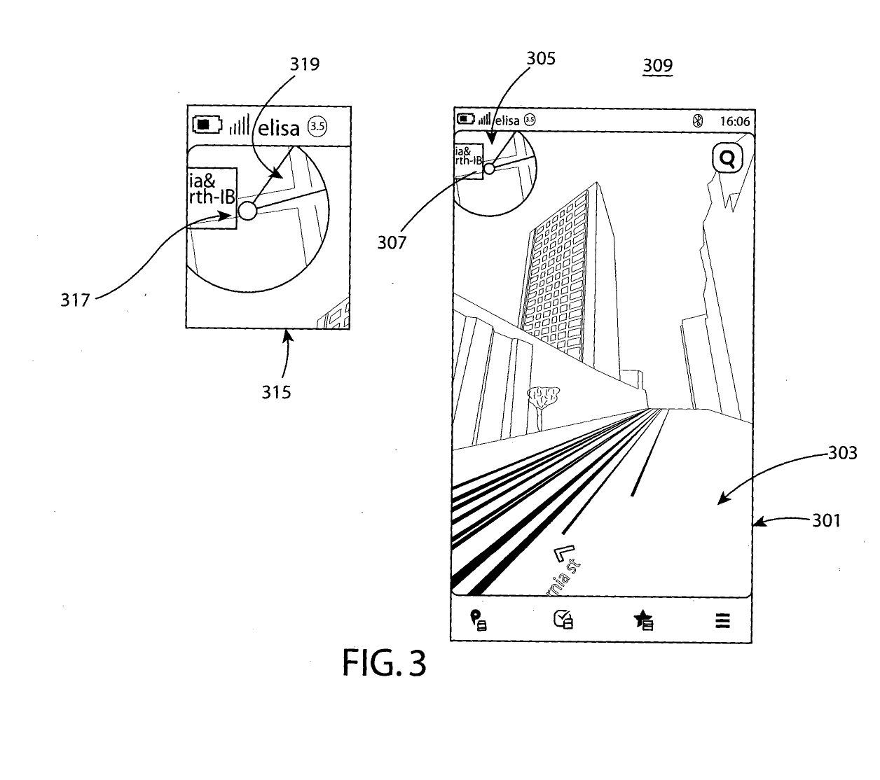

FIG. 3 shows a field of view on a plan view of a user interface for the user equipment of FIG. 2;

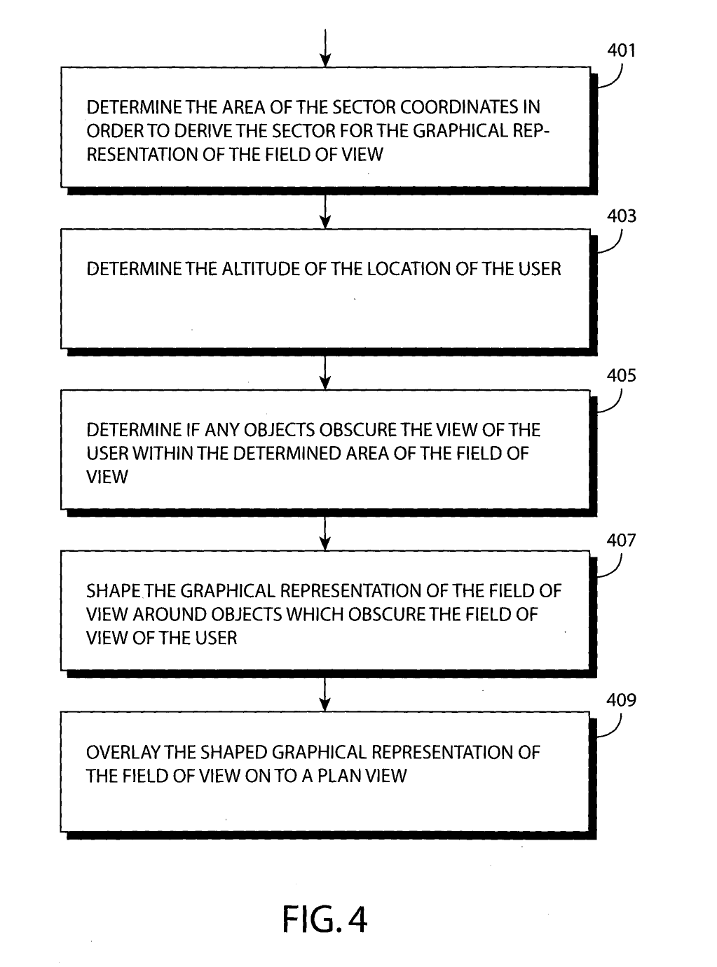

FIG. 4 shows a flow diagram of a process for projecting a field of view onto a plan view of the user interface of FIG. 3;

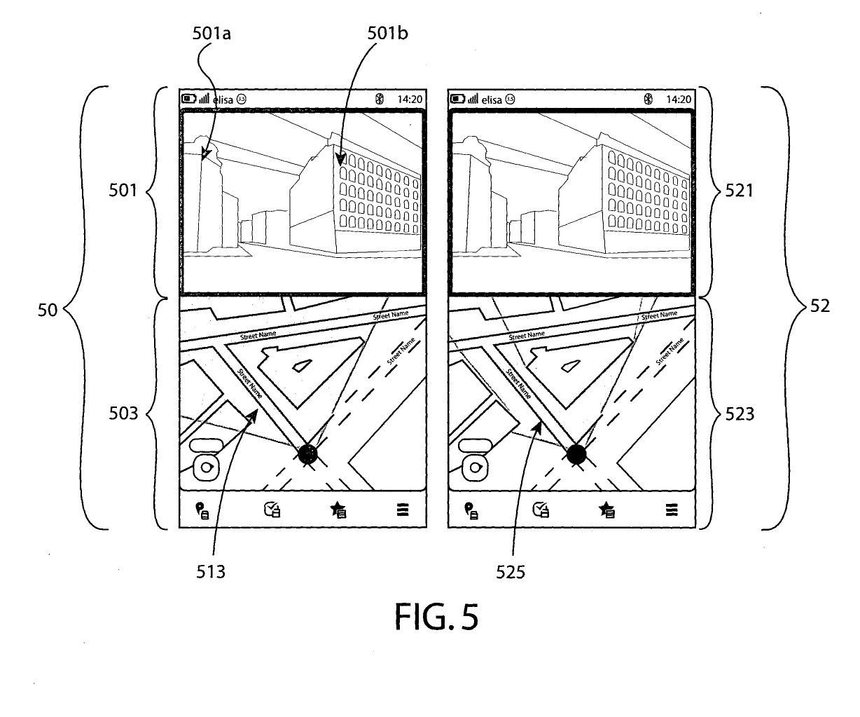

FIG. 5 shows an example user interface for an example embodiment;

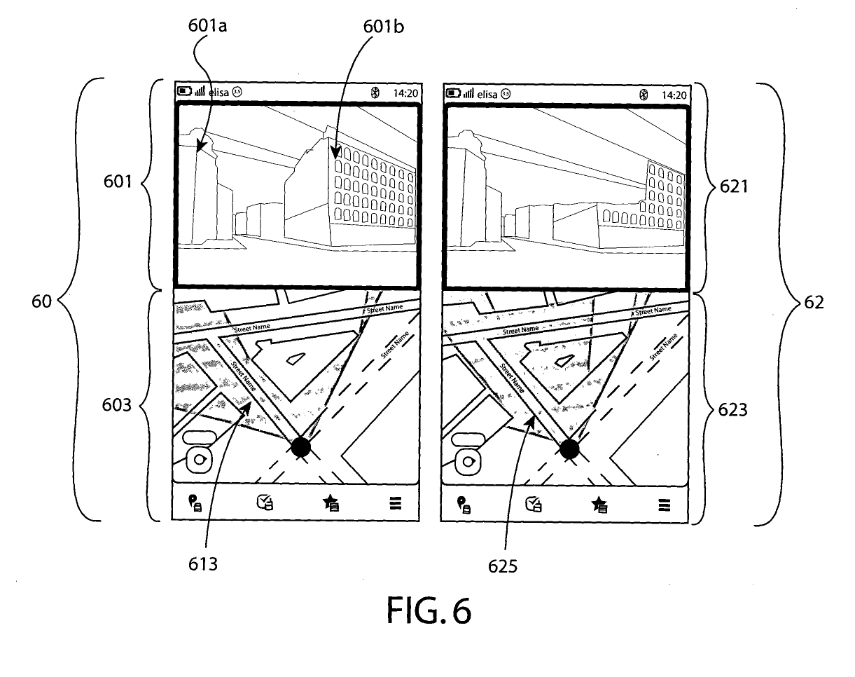

FIG. 6 shows a further example user interface for an example embodiment;

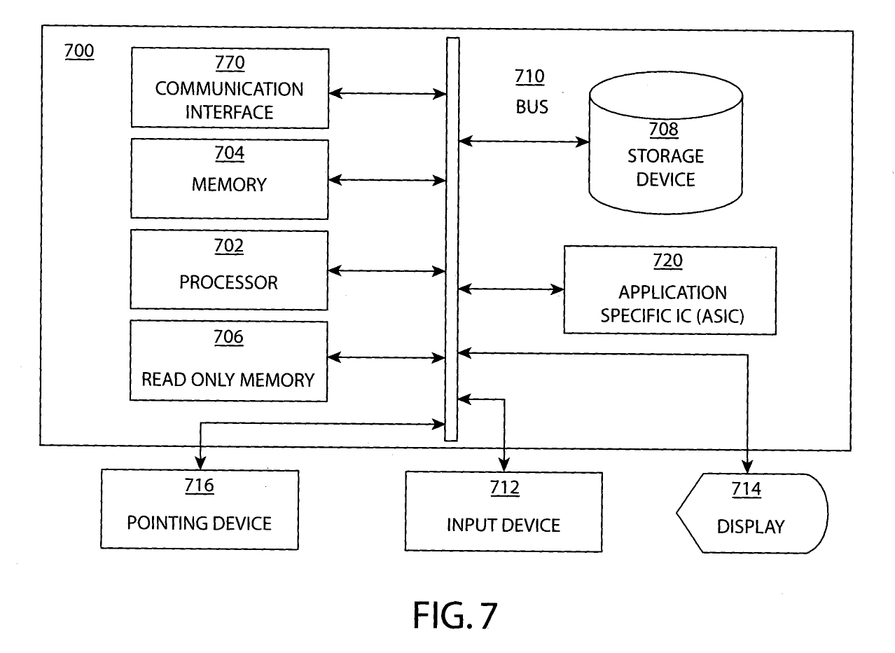

FIG. 7 shows schematically hardware that can be used to implement an embodiment of the invention; and

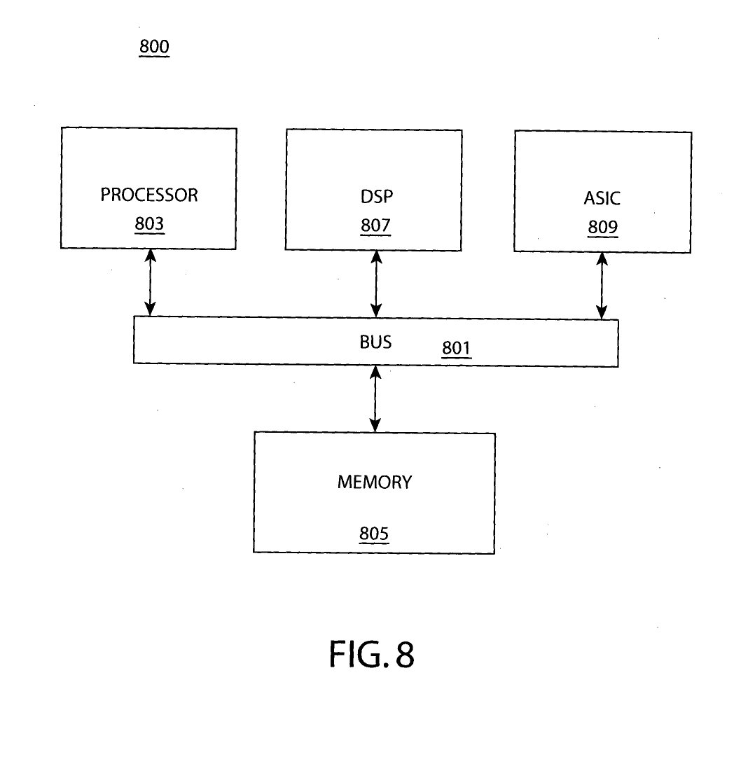

FIG. 8 shows schematically a chip set that can be used to implement an embodiment of the invention.

### DESCRIPTION OF SOME EMBODIMENTS OF THE APPLICATION

The following describes in further detail suitable apparatus and possible mechanisms for the provision of providing two and three dimensional mapping with a projected field of view of a user. In this regard reference is first made to FIG. 1 which shows a schematic block diagram capable of employing embodiments.

The system 100 of FIG. 1 may provide the capability for providing mapping information with a user's projected field of view and content related thereto for location based services on a mobile device. The system 100 can render a user interface for a location based service that has a main view portion and a preview portion, which can allow a user to simultaneously visualize both a perspective view which may comprise panoramic images of an area, and a corresponding plan view or map view of the area. This can enable a user to browse a panoramic view, whilst viewing a map of the surrounding area corresponding to the panoramic view. Or alternatively, when a user browses the map view he or she may be presented with a panoramic image corresponding to the browsed area on the map.

With reference to FIG. 1 the user equipment (UE) 101 may retrieve content information and mapping information from a content mapping platform 103 via a communication network 105. In some embodiments examples of mapping information retrieved by the UE 101 may be at least one of maps, GPS data and pre-recorded panoramic views.

The content and mapping information retrieved by the UE 101 may be used by a mapping and user interface application 107. In some embodiments the mapping and user interface application 107 may comprise an augmented reality application, a navigation application or any other location based application.

With reference to FIG. 1, the content mapping platform 103 can store mapping information in the map database 109a and content information in the content catalogue 109b. In embodiments, examples of mapping information may include digital maps, GPS coordinates, pre-recorded panoramic views, geo-tagged data, points of interest data, or any combination thereof. Examples of content information may include identifiers, metadata, access addresses such as Uniform Resource Locator (URL) or an Internet Protocol (IP) address, or a local address such as a file or storage location in the memory of the UE 101.

In some embodiments content information may comprise live media such as streaming broadcasts, stored media, metadata associated with media, text information, location information relating to other user devices, or a combination thereof.

In some embodiments the map view and content database 117 within the UE 101 may be used in conjunction with the application 107 in order to present to the user a combination of content information and location information such as mapping and navigational data.

In such embodiments the user may be presented with an augmented reality interface associated with the application 107, and together with the content mapping platform may be configured to allow three dimensional objects or representations of content to be superimposed onto an image of the surroundings. The superimposed image may be displayed within the UE 101.

For example, the UE 101 may execute an application 107 in order to receive content and mapping information from the content mapping platform 103. The UE 101 may acquire GPS satellite data 119 thereby determining the location of the UE 101 in order to use the content mapping functions of the content mapping platform 103 and application 107.

Mapping information stored in the map database 109a may be created from live camera views of real world buildings and locations. The mapping information may then be augmented into pre-recorded panoramic views and/or live camera views of real world locations.

By way of example, the application 107 and the content mapping platform 103 receive access information about content, determines the availability of the content based on the access information, and then presents a pre-recorded panoramic view or a live image view with augmented content (e.g., a live camera view of a building augmented with related content, such as the building's origin, facilities information: height, a number of floor, etc.). In certain embodiments, the content information may include 2D and 3D digital maps of objects, facilities, and structures in a physical environment (e.g., buildings).

The communication network 105 of the system 100 can include one or more networks such as a data network, a wireless network, a telephony network or any combination thereof. In embodiments the data network may be any of a Local area network (LAN), metropolitan area network (MAN), wide area network (WAN), a public data network, or any other suitable packet-switched network. In addition, the wireless network can be, for example, a cellular network and may employ various technologies including enhanced data rates for mobile communications (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 may be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

For example, the UE 101, and content mapping platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

In one group of embodiments, the application 107 and the content mapping platform 103 may interact according to a client-server model, so that the application 107 of the UE 101 requests mapping and/or content data from the content mapping platform 103 on demand. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

With reference to FIG. 2 there is shown a diagram of the components for a mapping and user interface application according to some embodiments. The mapping and user interface application 107 may include one or more components for correlation and navigating between a live camera image and a pre-recorded panoramic image. The functions of these components may be combined in one or more components or performed by other components of equivalent functionality. In these embodiments, the mapping and user interface application 107 includes at least a control logic 201 which executes at least one algorithm for executing functions of the mapping and user interface application 107. For example, the control logic 201 may interact with an image module 203 to provide to a user a live camera view of the surroundings of a current location. The image module 203 may include a camera, a video camera, or a combination thereof. In some embodiments, visual media may be captured in the form of an image or a series of images.

In some embodiments the control logic 201 interacts with a location module 205 in order to retrieve location data for the current location of the UE 101. In one group of embodiments, location data may include addresses, geographic coordinates such as GPS coordinates, or any other indicators such as longitude and latitude coordinates that can be associated with the current location.

In some embodiments location data may be retrieved manually by a user entering the data. For example, a user may enter an address or title, or the user may instigate retrieval of location data by clicking on a digital map. Other examples of obtaining location data may include extracting or deriving information from geo tagged data. Furthermore in some embodiments, location data and geo tagged data could also be created by the location module 205 by deriving the location data associated with media titles, tags and comments. In other words, the location module 205 may parse metadata for any terms that may be associated with a particular location.

In some embodiments, the location module 205 may determine the user's location by a triangulation system such as a GPS, assisted GPS (A-GPS), Differential GPS (DGPS), Cell of Origin, wireless local area network triangulation, or other location extrapolation technologies. Standard GPS and A-GPS systems can use satellites 119 to refine the location of the UE 101 GPS coordinates can provide finer detail as to the location of the UE 101.

As mentioned above, the location module 205 may be used to determine location coordinates for use by the application 107 and/or the content mapping platform 103.

The control logic 201 can interact with the image module 203 in order to display the live camera view or perspective view of the current or specified location. While displaying the perspective view of the current or specified location, the control logic 201 can interact with the image module 203 to receive an indication of switching views by the user by, for example, touching a “Switch” icon on the screen of the UE 101.

In some embodiments, the control logic 201 may also interact with a correlating module 207 in order to correlate the live image view with a pre-recorded panoramic view with the location data, and also to interact with a preview module 209 to alternate/switch the display from the live image view to one or more preview user interface objects in the user interface or perspective view.

In another embodiment, the image module 203 and/or the preview module 209 may interact with a magnetometer module 211 in order to determine horizontal orientation and a directional heading (e.g., in the form compass heading) for the UE 101. Furthermore the image module 203 and/or preview module 209 may also interact with an accelerometer module 213 in order to determine vertical orientation and an angle of elevation of the UE 101.

Interaction with the magnetometer and accelerometer modules 211 and 213 may allow the image module 203 to display on the screen of the UE 101 different portions of the pre-recorded panoramic or perspective view, in which the displayed portions are dependent upon the angle of tilt and directional heading of the UE 101.

It is to be appreciated that the user can then view different portions of the pre-recorded panoramic view without the need to move or drag a viewing tag on the screen of the UE 101.

Furthermore, the accelerometer module 213 may also include an instrument that can measure acceleration, and by using a three-axis accelerometer there may be provided a measurement of acceleration in three directions together with known angles.

The information gathered from the accelerometer may be used in conjunction with the magnetometer information and location information in order to determine a viewpoint of the pre-recorded panoramic view to the user. Furthermore, the combined information may also be used to determine portions of a particular digital map or a pre-recorded panoramic view.

Therefore as the user rotates or tilts the UE 101 the control logic 201 may interact with the image module 203 in order to render a viewpoint in the pre-recorded panoramic view to the user.

The control logic 201 may also interact with both a content management module 215 and the image module 203 in order to augment content information relating to POIs in the live image.

As depicted in FIG. 2, content for augmenting an image may be received at least from a service platform 111, at least one of services 113a-113n and at least one of content providers 115a-115n.

The content management module 215 may then facilitate finding content or features relevant to the live view or pre-recorded panoramic view.

In embodiments the content may be depicted as a thumbnail overlaid on the UI map at the location corresponding to a point of interest.

In some embodiments where it is found that there is too much content to display all at once, the content management module 215 may animate the display of the content such that new content appears while older content disappears.

In some embodiments, the user map and content database 117 includes all or a portion of the information in the map database 109a and the content catalogue 109b. From the selected viewpoint, a live image view augmented with the content can be provided on the screen of the UE 101. The content management module 215 may then provide a correlated pre-recorded panoramic view from the selected view point with content generated or retrieved from the database 117 or the content mapping platform 103.

Content and mapping information may be presented to the user via a user interface 217, which may include various methods of communication. For example, the user interface 217 can have outputs including a visual component (e.g., a screen), an audio component (e.g., a verbal instructions), a physical component (e.g., vibrations), and other methods of communication. User inputs can include a touch-screen interface, microphone, camera, a scroll-and-click interface, a button interface, etc. Further, the user may input a request to start the application 107 (e.g., a mapping and user interface application) and utilize the user interface 217 to receive content and mapping information. Through the user interface 217, the user may request different types of content, mapping, or location information to be presented. Further, the user may be presented with 3D or augmented reality representations of particular locations and related objects (e.g., buildings, terrain features, POIs, etc. at the particular location) as part of a graphical user interface on a screen of the UE 101. As mentioned, the UE 101 communicates with the content mapping platform 103, service platform 111, and/or content providers 115a-115m to fetch content, mapping, and or location information. The UE 101 may utilize requests in a client server format to retrieve the content and mapping information. Moreover, the UE 101 may specify location information and/or orientation information in the request to retrieve the content and mapping information.

As mentioned above the user interface (UI) for embodiments deploying location based services can have a display which has a main view portion and a preview portion. This can allow the UI to display simultaneously a map view and a panoramic view of an area in which user may be located.

With reference to FIG. 3, there is shown an exemplarily diagram of a user interface for a UE 101 in which the display screen 301 is configured to simultaneously have both a main view portion 303 and a preview portion 305. In the UI shown in FIG. 3, the main view portion 303 is displaying perspective view in which a panoramic image is shown, and the preview portion 305 is displaying a plan view in which a map is shown.

It is to be appreciated in embodiments that the plan view (or map view) and the perspective view can either be displaying views based on the present location and orientation of the user equipment 101, or displaying views based on a location selected by the user.

With reference to FIG. 3 there is also shown an insert figure 315 showing an enlargement of the preview portion 305.

It is to be understood that the extent of the observable world that is seen at any given moment may be referred to as the Field of View (FOV) and may be dependent on the location and the orientation of the user.

In embodiments the FOV may be projected onto the plan view within the display of the device in a computer graphical format. For reasons of clarity the representation of the FOV overlaid on to the plan view may be referred to as the graphical representation of the FOV.

The extent and the direction of the projected area of the graphical representation of the FOV can be linked to the area and direction portrayed by the panoramic image presented within the perspective view.

For example in FIG. 3 the preview portion 305 shows the plan view and includes an orientation representation shown as a circle 307 and a cone shaped area 309 extending from the circle 307. The circle 307 and the cone shaped area 309 correspond respectively to the circle 317 and cone shaped area 319 in the insert figure 315. The circle 307 and the cone shaped area 309 may depict the general direction and area for which the FOV covers in relation to the panoramic image presented in the perspective view 303. In other words in this example the cone shaped area is the graphical representation of the FOV sector as projected on to the plan view 305, and the panoramic image presented in the perspective view 303 is related to the view that the user would see if he were at the location denoted by the circle 307 and looking along the direction of the cone 309.

With reference to FIG. 4 there is shown a flow chart depicting a process for projecting a graphical representation FOV sector onto a plan or map view 305.

In embodiments the FOV may be determined by using location data from the location module 205 and orientation information from the magnetometer module 211. As mentioned above the location data may comprise GPS coordinates, and the orientation information may comprise horizontal orientation and a directional heading. In some embodiments, this data is obtained live through sensors on the mobile device. In other embodiments, the user may input this information manually for example by selecting a location and heading from a map and panorama image.

In some embodiments, a user may also define the width of the FOV through a display, for example, by pressing two or more points on the display presenting a map or a panoramic image.

This information may be used to determine the width that the graphical representation of the FOV may occupy within the plan view. In other words the location and orientation data may be used to determine the possible sector coordinates and area that the graphical representation of the FOV may occupy within the plan view.

With reference to FIG. 3, the projected cone shaped area 309 represents the sector coordinates that a FOV may occupy within the plan view. In other words the cone shaped area 309 is the graphical representation of the FOV sector projected onto the plan view.

In some embodiments the graphical representation of the FOV may be implemented as opaque shading projected over the plan view.

The step of determining the area of the sector coordinates within the plan view in order to derive the area of the graphical representation of the FOV sector for the location of the user is shown as processing step 401 in FIG. 4.

The mapping and user interface application 107 may obtain the height above sea level, or altitude of the location of the user.

In some embodiments the altitude information may be stored as part of the User Map Content Data 117. A look up system may then be used to retrieve a particular altitude value for a global location.

However, in some embodiments the UE 101 may have a barometric altimeter module contained within. In these embodiments the application 107 can obtain altitude readings from the barometric altimeter.

In other embodiments the application 107 may obtain altitude information directly from GPS data acquired within the location module 205.

The step of determining the altitude of the location of the user is shown as processing step 403 in FIG. 4.

The application 107 may then determine whether there are any objects tall enough or wide enough to obscure the user's field of view within the area indicated by the confines of the FOV sector determined in step 401. For example in embodiments, the obscuring object may be a building of some description, or a tree, or a wall, or a combination thereof.

In other words, the application 107 may determine that an object in the cone area 309 may be of such a size and location that a user's view would at least be partially obscured by that object.

In the instance that an object is deemed to obscure the view of a user, the application 107 would determine that the graphical representation of the FOV as projected onto the plan view may not be an accurate representation of the user's FOV.

In embodiments the above determination of whether objects obscure the possible field of view of the user may be performed by comparing the height and width of the object with the altitude measurement of the current location.

For example, a user's current location may be obtained from the GPS location coordinates. The map database 109a may store topographic information, in other words, information describing absolute heights (e.g. meters above sea level) of locations or information describing the relative heights between locations (e.g. that one location is higher than another location). The application 107 may then determine the heights of the locations in the FOV by comparing the height of the current location to the heights of the locations in the FOV. The application 107 can then determine whether a first object at a location in the FOV is of sufficient height such that it obscures a second object at a location behind the first object.

In some embodiments, the content catalogue 109b may store information relating to the heights and shapes of the buildings in the FOV. For example, the content catalogue 109b may store 3D models aligned with the objects in the image. The 3D models having been obtained previously by a process of laser scanning when the image was originally obtained. Furthermore the 3D models may also be obtained separately and then aligned with the images using the data gathered by Light Detection and Ranging (LIDAR).

In embodiments the application 107 can determine the height of a building and to what extent it is an obscuring influence over other buildings in the FOV.

In other words there may be provided means for determining an image of at least one object in a perspective view of a user interface which corresponds to the at least one object in a field of view, the at least one object obscures at least part of an area of the field of view.

The step of determining if any objects can obscure the view of the user within the area indicated by the confines of the graphical representation of the FOV is shown as processing step 405 in FIG. 4.

Should the previous processing step 405 determine that an object would obscure areas within the FOV the application 107 may then adjust the graphical representation of the FOV such that it more closely reflects the view the user would have in reality. In other words the graphical representation of the FOV projected onto the plan view may be shaped around any obscuring objects, thereby reflecting the actual view of the user.

For reasons of clarity the graphical representation of the FOV which has been adjusted to take into account obscuring objects may be referred to as the shaped or rendered graphical representation of the FOV sector.

In embodiments there is a shaping or rendering of the graphical representative FOV around the position of the at least one object which at least in part obscures the field of view as it occurs projected in the plan view of the user interface.

In other words there may be provided means for rendering a graphical representation of the FOV in the user interface to represent at least part of an area of the FOV which is obscured by the at least one object.

The step of shaping the graphical representation of the FOV around any objects deemed to be obscuring the view of the user is shown as processing step 407 in FIG. 4.

In embodiments the shaped graphical representation of the FOV may be projected onto the plan view of the display.

In other words there may be provided means for overlaying the rendered graphical representation of the FOV on a plan view of the user interface. The plan view corresponds to a map of the perspective view of the user interface.

The step of projecting or overlaying the shaped graphical representation of the FOV on to the plan view is shown as processing step 409 in FIG. 4.

With reference to FIG. 5 there is shown an example of a shaped graphical representation of the FOV projected on to a plan view of the preview portion of a screen.

In that regard reference is first made to an image scene 50 which is split into two images 501 and 503. The top image 501 depicts a panoramic view (or perspective view) showing a street with two buildings 501a and 501b. The bottom image 503 depicts a corresponding plan view in which there is projected the graphical representation of the FOV 513 as determined by the processing step 401.

It is to be understood that the graphical representation of the FOV sector 513 projected onto the image scene 50 is an example of a FOV sector in which obscuring objects have not been accounted for.

With further reference to FIG. 5 there is shown further image scene 52 which is also split into two images 521 and 523. The top image 521 depicts the same panoramic view as that of the top image 501 in the image scene 50. The bottom image 523 depicts the corresponding plan view in which there is projected the FOV sector 525. The graphical representation of the FOV525 in this image has been shaped around obscuring objects. In other words the shaped graphical representation of the FOV sector 525 is the graphical representation of the FOV as produced by the processing step 407.

From FIG. 5 it is apparent that the advantage of the processing step 407 is to produce a graphical representation of the FOV area which more closely resembles the FOV the user has in reality.

In other words there is a shaping of the graphical representation of the FOV around an area at a specific position in the plan view of the user interface, in which the area at the specific position in the plan view represents both the position of the obscuring object in the FOV and at least part of the area of the FOV which is obscured by the obscuring object.

In some embodiments the user may want to see behind a particular object such as building which may be obscuring the view. In these embodiments the user may select the particular object for removal from the panoramic image, thereby indicating to the application 107 that the user requires a view in the panoramic image of what is behind the selected object.

It is to be understood in some embodiments there may be a view from a live camera rather than a panoramic image. In these embodiments the live camera view may be supplemented with data to give an augmented reality view. In these embodiments the user can select a particular object for removal from the augmented reality view.

In embodiments the obscuring object may be removed from the panoramic image by a gesture on the screen such as a scrubbing motion or a pointing motion.

When the gesture is detected by the application 107, the panoramic image may be updated by the application 107 by removing the selected obscuring object. Furthermore, in embodiments the panoramic image may be augmented with imagery depicting the view a user would have should the object be removed in reality.

In other embodiments the gesture may indicate that the selected obscuring object can be removed from the augmented reality view. In these embodiments the resulting view may be a combination of a live camera view and a pre-recorded image of the view behind the selected obscuring object.

In other words there may be provided means for processing an indication to the user interface indicating that at least part of the image of the at least one object in the perspective view of the user interface which at least in part obscures at least part of an area in the field of view can be removed from the perspective view of the user interface.

Accordingly, in embodiments the shaped representative FOV sector projected onto the plan view may be updated to reflect the removal of an obscuring object from the panoramic image.

In other words there may be provided means for rendering the graphical representation of the field of view in the user interface to represent the field of view resulting from the removal of the at least part of the image of the at least one object in the perspective view of the user interface.

With reference to FIG. 6 there is shown an example of a shaped or rendered representation of the FOV sector having been updated as a consequence of an obscuring object being removed from the panoramic image.

In that regard reference is first made to an image scene 60 which is split into two images 601 and 603. The top image 601 depicts a panoramic view (or perspective view) showing a street with two buildings 601a and 601b. The bottom image 603 depicts a corresponding plan view in which there is projected the shaped graphical representation of the FOV sector 613 as determined by the processing step 407. It can be seen in the bottom image 603 that in this case the graphical representation of the FOV sector 613 has been shaped around the obscuring objects 601a and 601b.

There is also shown in FIG. 6 a further image scene 62 which is also split into two images 621 and 623. The top image 621 depicts the same panoramic view as that of the top image 601 in the image scene 60. However in this instance the user as performed a gesture on the UI which has resulted in the removal of the side of the building 601b.

The bottom image 623 depicts the corresponding plan view in which there is projected the shaped graphical representation of the FOV 625. However in this instance the shaped graphical representation of the FOV sector 625 has been updated to reflect the view a user would see should an obscuring object, in this case the side of the building 601b, is removed.

Example obscuring objects may include a building, a tree, or a hill.

The processes described herein for projecting a field of view of a user on to two or three dimensional mapping content for location based services on a mobile device may be implemented in software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

With reference to FIG. 7 there is illustrated a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to display interactive preview information in a location-based user interface as described herein and includes a communication mechanism such as a bus 710 for passing information between other internal and external components of the computer system 700.

The Computer system 700, or a portion thereof, constitutes a means for performing one or more steps of updating the field of view as part of an interactive preview information in a location-based user interface.

A processor (or multiple processors) 702 performs a set of operations on information as specified by computer program code related to updating the field of view as part of an interactive preview information in a location-based user interface. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, may store information including processor instructions for displaying interactive preview information in a location-based user interface. Dynamic memory allows information stored therein to be changed by the computer system 700. RAM allows a unit of information stored at a location called a memory address to be stored and retrieved independently of information at neighbouring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for displaying interactive preview information in a location-based user interface, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes.

The Computer system 700 also includes one or more instances of a communications interface 770 coupled to bus 710. Communication interface 770 provides a one-way or two-way communication coupling to a variety of external devices that operate with their own processors, such as printers, scanners and external disks. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 610 into signals for a communication connection over a coaxial cable or into optical signals for a communication connection over a fibre optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals that carry information streams, such as digital data. For example, in wireless handheld devices, such as mobile telephones like cell phones, the communications interface 770 includes a radio band electromagnetic transmitter and receiver called a radio transceiver. In some embodiments the communication interface 770 enables connection to wireless networks using a cellular transmission protocol such as global evolution (EDGE), general packet radio service (GPRS), global system for mobile communication (GSM), Internet protocol multimedia systems (IMS), universal mobile telecommunications systems (UMTS) etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof. In certain embodiments, the communications interface 770 enables connection to the communication network 105 for displaying interactive preview information in a location-based user interface via the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fibre optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

With reference to FIG. 8 there is illustrated a chip set or chip 800 upon which an embodiment of the invention may be implemented. Chip set 800 is programmed to display interactive preview information in a location-based user interface as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of updating the field of view as part of an interactive preview information in a location-based user interface.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to display interactive preview information in a location-based user interface. The memory 805 also stores the data associated with or generated by the execution of the inventive steps.

1-28. (canceled)

29. A method comprising:
determining an image of at least one object in a perspective view of a user interface which corresponds to at least one object in a field of view, wherein the at least one object obscures at least part of an area of the field of view;
rendering a graphical representation of the field of view in the user interface to represent the at least part of the area of the field of view which is obscured by the at least one object; and
overlaying the rendered graphical representation of the field of view on a plan view of the user interface, wherein the plan view corresponds to a map of the perspective view of the user interface.

30. The method as claimed in claim 29 further comprising:
processing an indication to the user interface indicating that at least part of the image of the at least one object in the perspective view of the user interface is to be removed from the perspective view of the user interface; and
rendering the graphical representation of the field of view in the user interface to represent the field of view resulting from the removal of the at least part of the image of the at least one object in the perspective view of the user interface.

31. The method as claimed in claim 29, wherein rendering the graphical representation of the field of view in the user interface to represent the at least part of the area of the field of view which is obscured by the at least one object comprises:
shaping the graphical representation of the field of view around an area at a specific position in the plan view of the user interface, wherein the area at the specific position in the plan view represents both the position of the at least one object in the field of view and the at least part of the area of the field of view which is obscured by the at least one object.

32. The method as claimed in claim 31 further comprising:
augmenting the perspective view of the user interface with image data portraying the view behind the at least part of the at least one object when the at least part of the image of the at least one object is indicated for removal in the perspective view of the user interface.

33. The method as claimed in claim 29, wherein the perspective view of the user interface comprises a panoramic image of an area comprising the field of view.

34. The method as claimed in claim 29, wherein the perspective view of the user interface comprises a live camera view of an area comprising the field of view.

35. The method as claimed in claim 29, wherein the user interface is at least part of a location based service of a mobile device.

36. An apparatus comprising at least one processor and at least one memory including computer code for one or more programs, the at least one memory and the computer code configured with the at least one processor to cause the apparatus at least to:
determine an image of at least one object in a perspective view of a user interface which corresponds to at least one object in a field of view, wherein the at least one object obscures at least part of an area of the field of view;
render a graphical representation of the field of view in the user interface to represent the at least part of the areas of the field of view which is obscured by the at least one object; and
overlay the rendered graphical representation of the field of view on a plan view of the user interface, wherein the plan view corresponds to a map of the perspective view of the user interface.

37. The apparatus as claimed in claim 36, wherein the at least one memory and the computer code configured with the at least one processor is further configured to cause the apparatus at least to:
process an indication to the user interface indicating that at least part of the image of the at least one object in the perspective view of the user interface is to be removed from the perspective view of the user interface; and
render the graphical representation of the field of view in the user interface to represent the field of view resulting from the removal of the at least part of the image of the at least one object in the perspective view of the user interface.

38. The apparatus as claimed in claim 36, wherein the at least one memory and the computer code configured with the at least one processor configured to cause the apparatus at least to render the graphical representation of the field of view in the user interface to represent the at least part of the area of the field of view which is obscured by the at least one object is further configured to cause the apparatus at least to:
shape the graphical representation of the field of view around an area at a specific position in the plan view of the user interface, wherein the area at the specific position in the plan view represents both the position of the at least one object in the field of view and the at least part of the area of the field of view obscured by the at least one object.

39. The apparatus as claimed in claim 38, wherein the at least one memory and the computer code configured with the at least one processor is further configured to cause the apparatus at least to:
augment the perspective view of the user interface with image data portraying the view behind the at least part of the at least one object when the at least part of the image of the at least one object is indicated for removal in the perspective view of the user interface.

40. The apparatus as claimed in claim 36, wherein the perspective view of the user interface comprises a panoramic image of an area comprising the field of view.

41. The apparatus as claimed in claim 36, wherein the perspective view of the user interface comprises a live camera view of an area comprising the field of view.

42. The apparatus as claimed in claim 36, wherein the user interface is at least part of a location based service of a mobile device.

43. A computer program code when executed by a processor realizes:
determining an image of at least one object in a perspective view of a user interface which corresponds to at least one object in a field of view, wherein the at least one object obscures at least part of an area of the field of view;
rendering a graphical representation of the field of view in the user interface to represent the at least part of the area of the field of view which is obscured by the at least one object; and
overlaying the rendered graphical representation of the field of view on a plan view of the user interface, wherein the plan view corresponds to a map of the perspective view of the user interface.

44. The computer program code, as claimed in claim 43, wherein the computer program code when executed by the processor further realizes:
processing an indication to the user interface indicating that at least part of the image of the at least one object in the perspective view of the user interface is to be removed from the perspective view of the user interface; and
rendering the graphical representation of the field of view in the user interface to represent the field of view resulting from the removal of the at least part of the image of the at least one object in the perspective view of the user interface.

45. The computer program code, as claimed in claim 43, wherein the computer program code when executed by the processor realizes rendering the graphical representation of the field of view in the user interface to represent the at least part of the area of the field of view which is obscured by the at least one object further realizes:
shaping the graphical representation of the field of view around an area at a specific position in the plan view of the user interface, wherein the area at the specific position in the plan view represents both the position of the at least one object in the field of view and the at least part of the area of the field of view which is obscured by the at least one object.

46. The computer program code as claimed in claim 45, wherein the computer program code when executed by the processor further realizes:
augmenting the perspective view of the user interface with image data portraying the view behind the at least part of the at least one object when the at least part of the image of the at least one object is indicated for removal in the perspective view of the user interface.

47. The computer program code as claimed claim 43, wherein the perspective view of the user interface comprises a panoramic image of an area comprising the field of view.

48. The computer program code as claimed in claim 43, wherein the perspective view of the user interface comprises a live camera view of an area comprising the field of view.
